(19) United States
(12) Patent Application Publication
(10) Pub. No.: US 2016/0008106 A1
(43) Pub. Date: Jan. 14, 2016

(54) METHOD AND APPARATUS OF FULL MOUTH RECONSTRUCTION

(71) Applicants: WEN-HSIN CHIOU, Taichung City (TW); JHEN-GUO TSAI, Tainan City (TW)

(72) Inventors: WEN-HSIN CHIOU, Taichung City (TW); JHEN-GUO TSAI, Tainan City (TW)

(21) Appl. No.: 14/327,790

(22) Filed: Jul. 10, 2014

(51) Int. Cl. A61C 9/00; A61C 19/045

(52) U.S. Cl. CPC A61C 9/0006; A61C 19/045

(57) ABSTRACT

A full mouth reconstruction method and apparatus includes a denture molding structure mounted onto a patient's maxilla and mandible after being filled with an impression material, so that a static molding of the patient's gum can be performed based on the patient's occlusion. Important reference data including the vertical height of occlusion, facial midline, horizontal occlusion line, connecting line between two pupils and nose-ear horizontal line are recorded for facial and oral reconstructions while the patient is biting a first recording device, and the facial movements of the patient's chewing and speaking are recorded quickly while the patient is biting a second recording device. Records of a metal calibration are applied to obtain data of a patient's front-and-rear, left-and-right, and up-and-down maxillary and mandibular movements through facial movements of a patient's chewing and speaking, and these data are provided to a dental mold technician for producing the denture.

### BACKGROUND OF THE INVENTION

1. Fields of the Invention

The present invention relates to a full mouth reconstruction method and apparatus, and more particularly, to a full mouth reconstruction method and apparatus capable of quickly recording a patient's data for one time, accurately determining the appropriateness of mounting a denture, and lowering the error of manufacturing the denture.

2. Descriptions of Related Art

In general, replaceable artificial teeth are mounted for people whose teeth have all fallen out or required extraction due to factors including medical treatment, unexpected contraction, disease or old age.

The most common full mouth denture is in form of a movable denture and generally includes a whole set of maxillary teeth and mandibular teeth, and the size and shape of the full mouth denture are adjusted before the full mouth denture is mounted onto a patent's maxillary and madibular soft tissues for the purpose of an oral and dental rehabilitation.

As material science advances, the denture becomes increasingly stronger and more durable and comes with a natural look, and the development of denture design improves a patient's comfort and chewing efficiency.

However, the denture is generally tailored according to the shape of a patient's arch for its production and processing and thus cannot be mass produced, and the production process generally includes several times of communications between the patient and dentist during the clinical treatment, so that it takes much time before the denture can be produced, and the patient has to bear with the inconvenience caused during the period of producing the denture. After the denture is produced and mounted, the patient still needs to go through the processes of adapting the maxillary and mandibular occlusions and correcting the error (including the mold transfer error) caused by clinical and dental technologies, so that it further lengthens the time required for the production of the denture, increases the transportation cost, and causes discomfort to the patient in the period of adapting a newly installed denture. Obviously, the prior art requires further improvements.

### SUMMARY OF THE INVENTION

The primary object of the present invention is to provide a full mouth reconstruction method and apparatus capable of providing accurate maxillary and mandibular arches, taking samples quickly, and determining the appropriateness of mounting a patient's denture accurately.

Another objective of the present invention is to provide a full mouth reconstruction method and apparatus that obtains the facial occlusion records after the operation of a first-time impression takes place, integrates more accurate parameters of an extraoral occluder, and then performs a more accurate second-time impression and takes dynamic occlusal movement records of the patient, and finally uses the concept of statistics to reduce the range of error of the first-time and second-time operations for the full mouth in order to produce a full mouth reconstruction.

A further objective of the present invention is to provide a full mouth reconstruction method and apparatus capable of scribing and recording a patient's midline and lips to achieve a visually symmetric beautification effect of the full mouth reconstruction.

Another objective of the present invention is to provide a full mouth reconstruction method and apparatus capable of reducing the error of producing the denture, reconstructing a toothless patient's facial and oral damages, and providing a good chewing function and a high appropriateness of the installation.

Another objective of the present invention is to provide a full mouth reconstruction method and apparatus capable of recording a vertical height of a patient's occlusion, facial midline, horizontal occlusion line, a connected line between two pupils and a nose-ear line at a time to provide important reference data for facial and oral reconstruction.

Another objective of the present invention is to provide a full mouth reconstruction method and apparatus capable of applying the record of a metal calibration to obtain the data of a patient's front-and-rear, left-and-right, and up-and-down maxillary and mandibular movements through the facial movements of a patient's chewing and speaking, and providing these accurate data to a dental mold technician for producing the denture.

To achieve the aforementioned and other objectives, the present invention provides a full mouth reconstruction method, comprising:

a step of performing a static molding of a patient's gum, wherein a denture molding structure is mounted onto the patient's maxilla and mandible after the denture molding structure is filled with an impression material, so that the static molding of the patient's gum can be performed based on the patient's occlusion;
a step of recording a horizontal line and a vertical line of the patient's occlusion, wherein a vertical height, a facial midline, a horizontal occlusion line, a connecting line between two pupils and a nose-ear horizontal line of the patient are recorded quickly to provide important reference data for facial and oral reconstructions while the patient is biting a first recording device; and
a step of recording the patient's dynamic and static occlusions, wherein facial movements of a patient's chewing and speaking are recorded quickly while the patient is biting a second recording device, and records of a metal calibration are applied to obtain the patient's front-and-rear, left-and-right, and up-and-down maxillary and mandibular movements through facial movements of a patient's chewing and speaking, and these data are provided to a dental mold technician for producing the denture.

The present invention further provides a full mouth reconstruction apparatus, wherein the denture molding structure is comprised of an upper mold and a lower mold, and a maxillary anterior region is defined at the front of the upper mold, and a board is installed at the top of the maxillary anterior region, and an arc extension plate is extended upwardly from a connecting position of the board and the maxillary anterior region, and an edge lifting plate is installed separately on both sides of the board and integrally formed with the extension plate, and a protrusion is formed at a central position of the board and abutted against the patient's maxilla; and

a mandibular anterior region is defined at the front of the lower mold, and an arc cheek gum portion is disposed separately on both sides of the mandibular anterior region, and a recession is formed at the bottom of each cheek gum portion and abutted against the patient's mandible, such that the top of the mandibular anterior region and the bottom of the maxillary anterior region of the upper mold are aligned precisely with each other through the patient's dental occlusion.

Wherein, the arc extension plate has a front recession formed at a central position thereof.

Wherein, each of the two edge lifting plates has a cheek recession formed at a position proximate to the middle position thereof.

Wherein, the two edge lifting plates have a plurality of holes formed at predetermined positions thereof respectively.

Wherein, the protrusion has a plurality of vent holes.

Wherein, the cheek gum portion has more than one vent hole.

Wherein, the maxillary anterior region and the mandibular anterior region have a label portion disposed at a middle position thereof, and the label portion has a longitudinal label and a plurality of horizontal labels perpendicular to the longitudinal label.

In the full mouth reconstruction apparatus, the first recording device is comprised of a vertical rod, a first horizontal rod, an occluder, a second horizontal rod and a third horizontal rod.

The vertical rod has a vertical chute and a penetrating member, and the penetrating member has a horizontal adjusting slot, and the first horizontal rod is screwed into an adjusting slot of the penetrating member of the vertical rod, and the occluder has a horizontal tablet, and an arc upper tab and an arc lower tab are disposed at the top and bottom of the tablet respectively, and the tablet is screwed to the first horizontal rod, and the second horizontal rod and the third horizontal rod are screwed to a chute of the vertical rod.

In the full mouth reconstruction apparatus, the second recording device is comprised of an arc upper seat, an upper plotting board with a connecting portion disposed at an end, an arc lower seat, and a lower plotting board, and the upper plotting board is installed at the bottom of the upper seat, and the lower plotting board is installed at the top of the lower seat, and the lower plotting board and the upper plotting board are attached with each other, and the upper seat, the upper plotting board, the lower seat and the lower plotting board are fixed by a plurality of screws.

Wherein, the connecting portion of the upper plotting board has a positioning notch.

Wherein, the upper and lower seats are made of an acrylic plastic material.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart of a reconstruction process of the present invention;

FIG. 2 is an exploded view of a denture molding structure of the present invention;

FIG. 3 is a perspective view of another denture molding structure of the present invention;

FIG. 4 is a perspective view of a further denture molding structure of the present invention;

FIG. 5 is a schematic view of installing a denture molding structure in accordance with a preferred embodiment of the present invention;

FIG. 6 is a schematic view of installing a first recording device in accordance with a preferred embodiment of the present invention;

FIG. 7 is a front view of installing a first recording device in accordance with a preferred embodiment of the present invention; and

FIG. 8 is a perspective view of a second recording device of the present invention; and

FIG. 9 is a schematic view of installing a second recording device in accordance with a preferred embodiment of the present invention.

### DETAILED DESCRIPTION OF THE PREFERRED EMBODIMENT

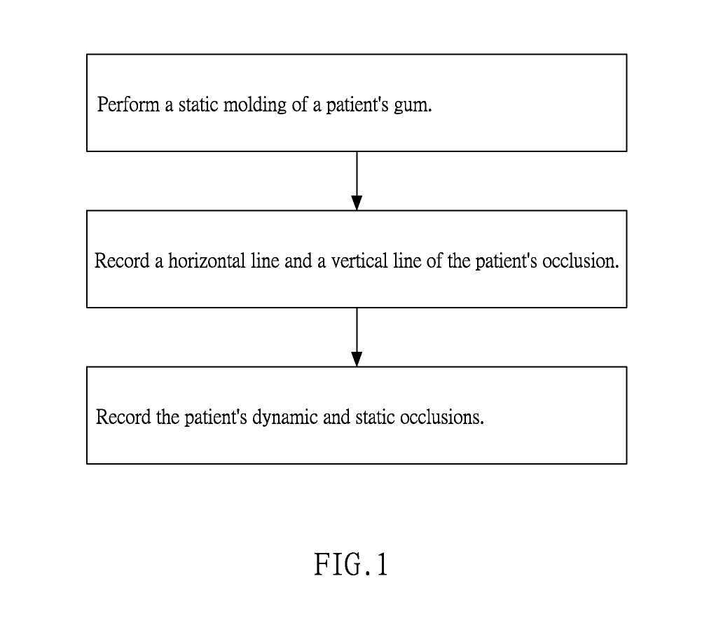

Referring to FIGS. 1 to 9, the full mouth reconstruction method of the present invention comprises:

a step of performing a static molding of a patient's gum, wherein a denture molding structure A is mounted onto the patient's maxilla and mandible after the denture molding structure is filled with an impression material, so that the static molding of the patient's gum can be performed based on the patient's occlusion;

a step of recording a horizontal line and a vertical line of the patient's occlusion, wherein a vertical height, a facial midline, a horizontal occlusion line, a connecting line between two pupils and a nose-ear horizontal line of the patient are recorded quickly to provide important reference data for facial and oral reconstructions while the patient is biting a first recording device B; and

a step of recording the patient's dynamic and static occlusions, wherein facial movements of a patient's chewing and speaking are recorded quickly while the patient is biting a second recording device C, and records of a metal calibration are applied to obtain the patient's front-and-rear, left-and-right, and up-and-down maxillary and mandibular movements through facial movements of a patient's chewing and speaking, and these data are provided to a dental mold technician for producing the denture.

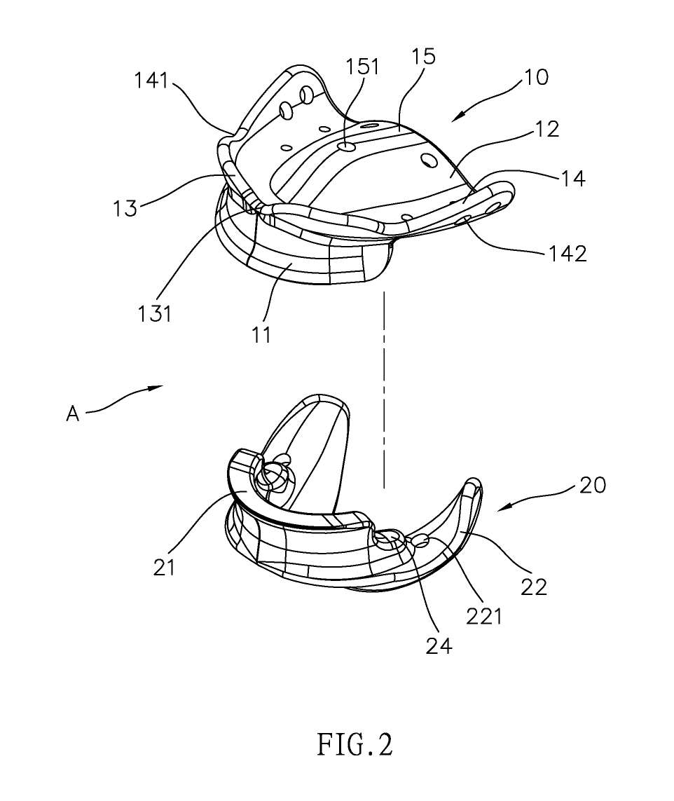

In addition, the present invention further provides a full mouth reconstruction apparatus, wherein, the denture molding structure A is comprised of an upper mold 10 and a lower mold 20, and a maxillary anterior region 11 is defined at the front of the upper mold 10, and a board 12 is installed at the top of the maxillary anterior region 11, and an arc extension plate 13 is extended upwardly from a connecting position of the board 12 and the maxillary anterior region 11, and an edge lifting plate 14 is installed separately on both sides of the board 12 and integrally formed with the extension plate 13, and a protrusion 15 is formed at a central position of the board 12 and abutted against the patient's maxilla (as shown in FIG. 2); and

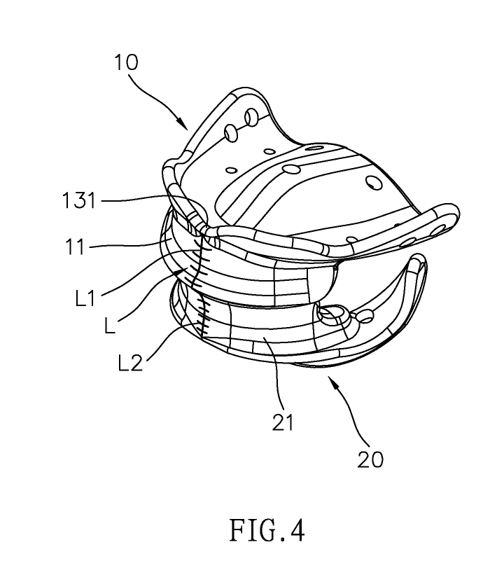

a mandibular anterior region 21 is defined at the front of the lower mold 20, and an arc cheek gum portion is disposed separately on both sides of the mandibular anterior region, and a recession is formed at the bottom of each cheek gum portion 22 (as shown in FIG. 2) and abutted against a recession (not shown in the figure) of the patient's mandible, such that the top of the mandibular anterior region 21 and the bottom of the maxillary anterior region 11 of the upper mold 10 are aligned precisely with each other through the patient's dental occlusion.

Wherein, a front recession 131 is formed at a central position of the arc extension plate 13 (as shown in FIG. 2).

Wherein, a cheek recession 141 is formed at a position proximate to the middle position of the two edge lifting plates 14 (as shown in FIG. 2).

Wherein, the two edge lifting plates 14 have a plurality of holes 142 formed at predetermined positions of the two edge lifting plates 14 respectively (as shown in FIG. 2).

Wherein, the protrusion 15 has a vent hole 151 (as shown in FIG. 2).

Wherein, the cheek gum portion 22 has more than one vent hole 221 (as shown in FIG. 2).

Wherein, a label portion L is disposed at the middle position of the maxillary anterior region 11 and the mandibular anterior region 21, and the label portion L has a longitudinal label L1 and a plurality of horizontal labels L2 perpendicular to the longitudinal label L1 (as shown in FIG. 4).

In addition, the present invention further provides a full mouth reconstruction apparatus, wherein, the first recording device B is comprised of a vertical rod 30, a first horizontal rod 40, an occluder 50, a second horizontal rod 60 and a third horizontal rod 70.

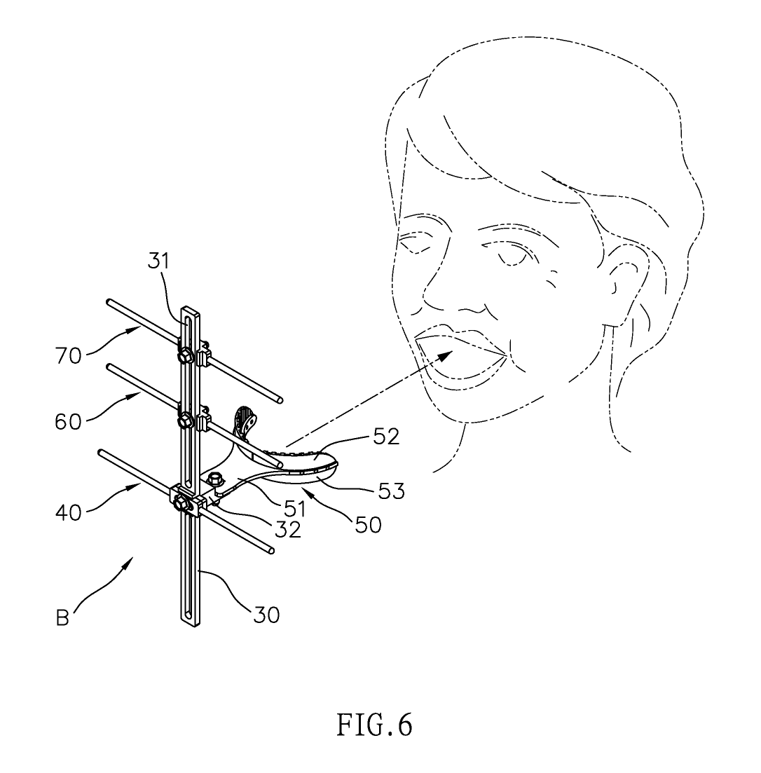

The vertical rod 30 has a vertical chute 31 and a penetrating member 32, and the penetrating member 32 has a horizontal adjusting slot (not shown in the figure), and the first horizontal rod 40 is screwed into an adjusting slot of the penetrating member 32 of the vertical rod 30, and the occluder 50 has a horizontal tablet 51, and an arc upper tab 52 and an arc lower tab 53 are disposed at the top and bottom of the tablet 51 respectively, and the tablet 51 is screwed to the first horizontal rod 40, and the second horizontal rod 60 and the third horizontal rod 70 are screwed to a chute 31 of the vertical rod 30 (as shown in FIG. 6).

The present invention further provides a full mouth reconstruction apparatus, wherein, the second recording device C is comprised of an arc upper seat C1,

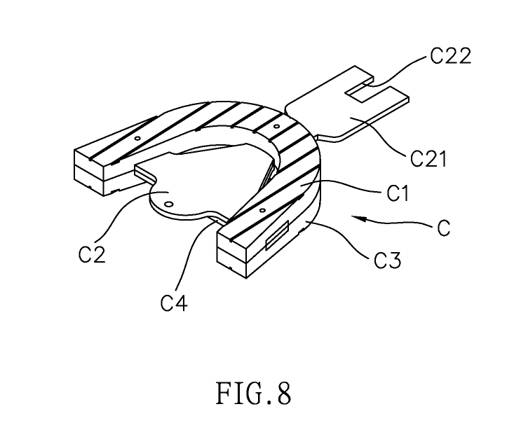

an upper plotting board C2 with a connecting portion C21 disposed at an end, an arc lower seat C3, and a lower plotting board C4, and the upper plotting board C2 is installed at the bottom of the upper seat C3, and the lower plotting board C4 is installed at the top of the lower seat C3, and the lower plotting board C4 and the upper plotting board C2 are attached with each other, and the upper seat C1, the upper plotting board C2, the lower seat C3 and the lower plotting board C4 are fixed by a plurality of screws (as shown in FIG. 8).

Wherein, the connecting portion C21 of the upper plotting board C2 has a positioning notch C22.

Wherein, the upper and lower seats C1, C3 are made of an acrylic plastic material.

With reference to the aforementioned assembly and FIGS. 1 to 9, when a patient wants to mount a full mouth denture, a denture molding structure A is provided for performing a static molding to obtain a first-time molding diagnostic and classify the size and shape of a patient's gum as the basis of manufacturing a personal tailor-made denture.

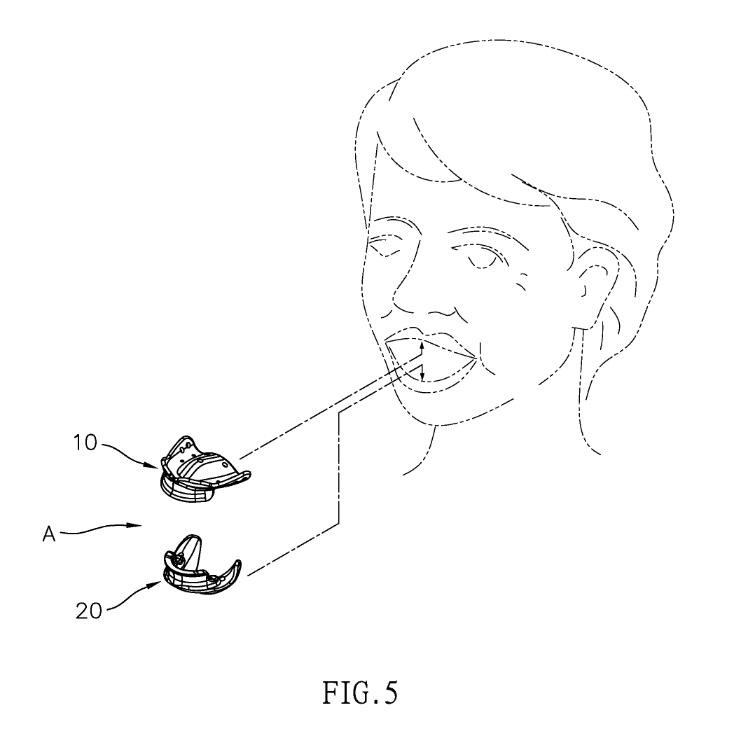

In the step of performing a static molding of a patient's gum, the top of the upper mold 10 and the bottom of the lower mold 20 of the denture molding structure A are mounted onto the patient's maxilla and mandible respectively (as shown in FIG. 5) after the denture molding structure A is filled with an impression material, so that the static molding of the patient's gum can be performed based on the patient's occlusion

Since a maxillary anterior region 11 is defined at the front of the upper mold 10, such arrangement may help reconstructing the upper lip of a toothless patient to a full and rounded shape, and the edge lifting plates 14 installed on both sides have a cheek recession 141 separately for reconstructing the external look of both cheeks, and the central position of the board 12 abuts against the protrusion 15 of the patient's maxilla and the vent hole 151 of the protrusion 15 to attach the board 12 to the patient's maxilla securely.

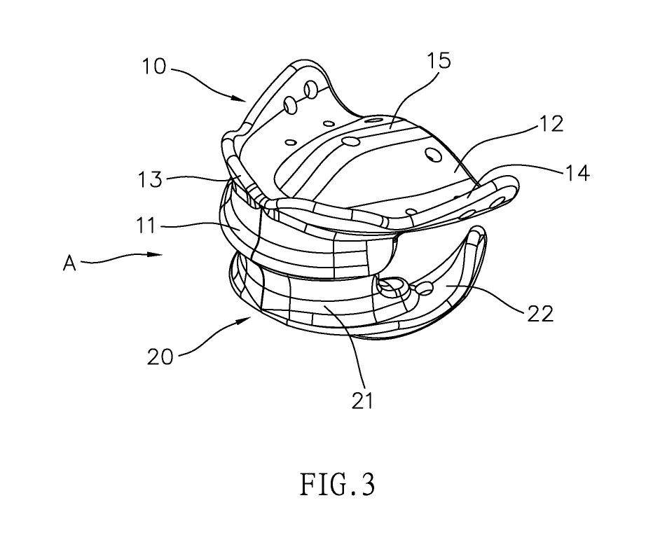

In addition, a mandibular anterior region 21 is defined at the front of the lower mold 20, such arrangement may help reconstructing the lower lip of the toothless patient to a full and rounded shape, and an arc cheek gum portion 22 is disposed separately on both sides of the mandibular anterior region 21 for reconstructing the external look of both cheeks and improving the comfort of installation, and the top of the mandibular anterior region 21 and the bottom of the maxillary anterior region 11 are aligned precisely with each other through the patient's dental occlusion (as shown in FIG. 3) to achieve the effects of providing accurate maxillary and madibular occlusions effectively, taking the sample quickly, determining the appropriateness of mounting a patient's denture, and preventing the manufacturing error of the denture, so as to reconstruct a toothless patient's facial and oral damages and the external look of the patient's lips and cheeks, and provide a good chewing movement, an accurate pronunciation function, a high comfort and a useful application.

In the present invention, the maxillary anterior region 11 and the mandibular anterior region 21 have a label portion L separately, and the label portion L has a longitudinal label L1 and a plurality of horizontal labels L2 (as shown in FIG. 4), so that the patient's midline and lips may be recorded to achieve the visually symmetric beautification effect of the full mouth reconstruction.

In the step of recording a horizontal line and a vertical line of the patient's occlusion, a vertical height, a facial midline, a horizontal occlusion line, a connecting line between two pupils and a nose-ear horizontal line of the patient are recorded quickly to provide important reference data for facial and oral reconstructions while the patient is biting a first recording device B.

An occluder 50 is provided for the patient's maxillary and mandibular occlusions, so that the horizontal height, left and right positions and angle of the first horizontal rod 40, second horizontal rod 60 and third horizontal rod 70 can be adjusted appropriately according to the vertical height, facial midline, horizontal occlusion line, connecting line between two pupils and nose-ear line of the patient's occlusion.

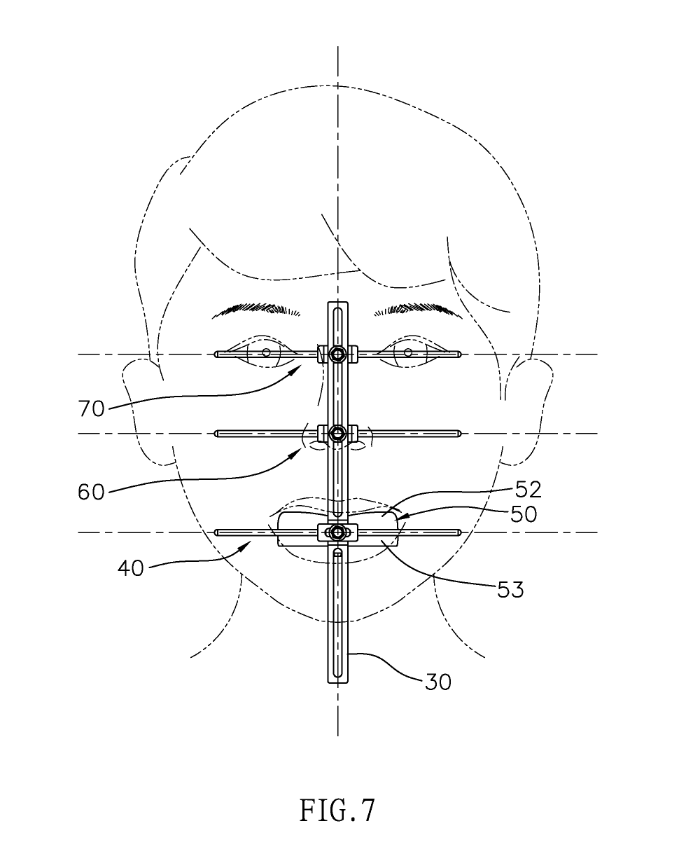

Since the second and third horizontal rods 60, 70 are screwed onto the chute 31 of the vertical rod 30, therefore the up-and-down horizontal height of the second and third horizontal rods 60, 70 on the chute 31 of the vertical rod 30 may be adjusted in order to adjust the patient's horizontal occlusion line, connecting line between two pupils and nose-ear line (as shown in FIG. 7). Obviously, the adjusting method is simple and convenience, and the invention is useful and practical.

After the patient is biting the first recording device B of the present invention for a time, a plurality of facial reference lines such as the vertical height, facial midline, horizontal occlusion line, connecting line between two pupils and nose-ear line of the patient's occlusion can be recorded quickly and transferred correctly to an extraoral recorder at a time, and then the data can be compiled for the manufacture of the full mouth denture without dividing the process into several parts or causing errors, so as to effectively and accurately provide the important reference data for the facial and oral reconstructions.

In the step of recording the patient's dynamic and static occlusions: facial movements of a patient's chewing and speaking are recorded quickly while the patient is biting a second recording device C, and records of a metal calibration are applied to obtain the patient's front-and-rear, left-and-right, and up-and-down maxillary and mandibular movements through facial movements of a patient's chewing and speaking, and these data are provided to a dental mold technician for producing the denture.

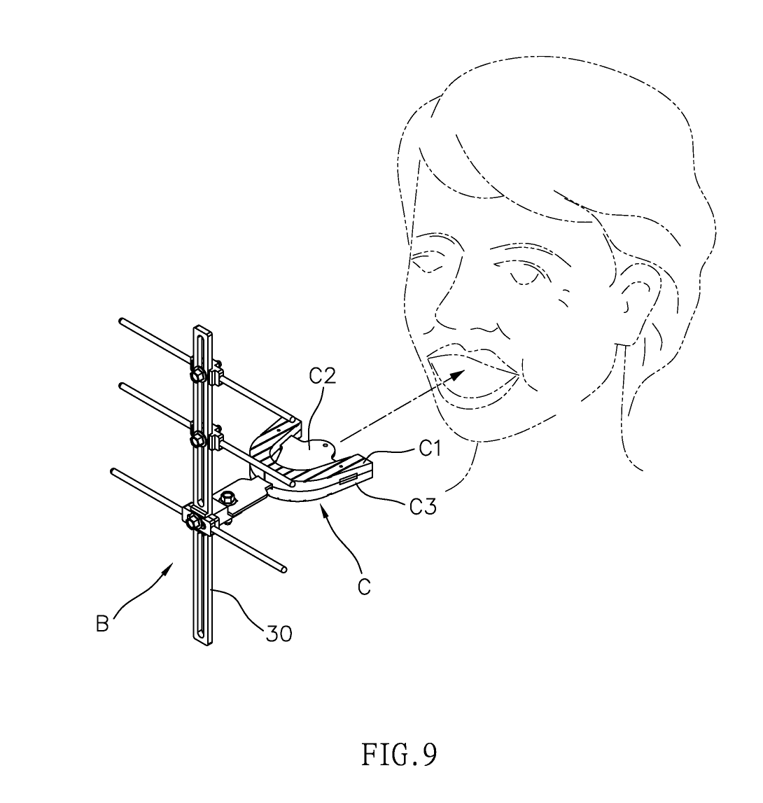

Since the second recording device C is installed on the first recording device B, or the connecting portion C21 of the upper plotting board C2 is passed through an adjusting slot of the vertical rod 30, such that after the patient has bitten the upper plotting board C2 for a time, the first recording device B may be used for recording a plurality of facial reference lines including the vertical height, facial midline, horizontal occlusion line, connecting line between two pupils and nose-ear line of the patient's occlusion quickly (as shown in FIG. 9), so as to provide important reference data for the facial and oral reconstructions.

Before the patient bites the upper plotting board C2, it is necessary to prepare upper and lower gum resins with a thickness of approximately 2 mm on the working plaster model, and provide the upper and lower gum resins for the patient to bite, and the patient's accurate and ideal occlusal height is used, so that the gum can bear the patient's occlusal force, and then dynamic movements are recorded.

For dynamic movement records, a patient uses the mandible to perform a protruding movement repeatedly in the oral cavity, and a sideway (left and right) movement, and finally returns the mandible to a static position, and such position is used for setting the relation with respect to the center position.

Therefore, the present invention may apply the record of a metal calibration to obtain the front-and-rear, left-and-right, and top-and-down maxillary and madibular movement data through the facial movements of a patient's chewing and speaking, and these data are provided to a dental mold technician as accurate data for manufacturing the denture. Obviously, the invention is useful and practical.

In summation of the description above, the full mouth reconstruction method and apparatus of the present invention overcomes the drawbacks of the conventional structure effectively by obtaining the facial occlusion records after the operation of a first-time impression takes place, integrating more accurate parameters of an extraoral occluder, and then performing a more accurate second-time impression and taking dynamic occlusal movement records of the patient, and finally using the concept of statistics to reduce the range of error of the first-time and second-time operations for the full mouth in order to produce a full mouth reconstruction.

While we have shown and described the embodiment in accordance with the present invention, it should be clear to those skilled in the art that further embodiments may be made without departing from the scope of the present invention.

What is claimed is:

1. A full mouth reconstruction method, comprising:
a step of performing a static molding of a patient's gum, wherein a denture molding structure is mounted onto the patient's maxilla and mandible after the denture molding structure is filled with an impression material, so that the static molding of the patient's gum can be performed based on the patient's occlusion;
a step of recording a horizontal line and a vertical line of the patient's occlusion, wherein a vertical height, a facial midline, a horizontal occlusion line, a connecting line between two pupils and a nose-ear horizontal line of the patient are recorded quickly to provide important reference data for facial and oral reconstructions while the patient is biting a first recording device; and
a step of recording the patient's dynamic and static occlusions, wherein facial movements of a patient's chewing and speaking are recorded quickly while the patient is biting a second recording device, and records of a metal calibration are applied to obtain the patient's front-and-rear, left-and-right, and up-and-down maxillary and mandibular movements through facial movements of a patient's chewing and speaking, and these data are provided to a dental mold technician for producing the denture.

2. An apparatus of the full mouth reconstruction method as claimed in claim 1, wherein the denture molding structure is comprised of an upper mold and a lower mold, and a maxillary anterior region is defined at the front of the upper mold, and a board is installed at the top of the maxillary anterior region, and an arc extension plate is extended upwardly from a connecting position of the board and the maxillary anterior region, and an edge lifting plate is installed separately on both sides of the board and integrally formed with the extension plate, and a protrusion is formed at a central position of the board and abutted against the patient's maxilla; and
a mandibular anterior region is defined at the front of the lower mold, and an arc cheek gum portion is disposed separately on both sides of the mandibular anterior region, and a recession is formed at the bottom of each cheek gum portion and abutted against the patient's mandible, such that the top of the mandibular anterior region and the bottom of the maxillary anterior region of the upper mold are aligned precisely with each other through the patient's dental occlusion.

3. The apparatus of full mouth reconstruction as claimed in claim 2, wherein the arc extension plate has a front recession formed at a central position thereof.

4. The apparatus of full mouth reconstruction as claimed in claim 2, wherein each of the two edge lifting plates has a cheek recession formed at a position proximate to the middle position thereof.

5. The apparatus of full mouth reconstruction as claimed in claim 2, wherein the two edge lifting plates have a plurality of holes formed at predetermined positions thereof respectively.

6. The apparatus of full mouth reconstruction as claimed in claim 2, wherein the protrusion has a vent hole.

7. The apparatus of full mouth reconstruction as claimed in claim 2, wherein the cheek gum portion has more than one vent hole.

8. The apparatus of full mouth reconstruction as claimed in claim 2, wherein the maxillary anterior region and the mandibular anterior region have a label portion disposed at a middle position thereof, and the label portion has a longitudinal label and a plurality of horizontal labels perpendicular to the longitudinal label.

9. The apparatus of full mouth reconstruction method as claimed in claim 1, wherein the first recording device is comprised of a vertical rod, a first horizontal rod, an occluder, a second horizontal rod and a third horizontal rod;
the vertical rod has a vertical chute and a penetrating member, and the penetrating member has a horizontal adjusting slot, and the first horizontal rod is screwed into an adjusting slot of the penetrating member of the vertical rod, and the occluder has a horizontal tablet, and an arc upper tab and an arc lower tab are disposed at the top and bottom of the tablet respectively, and the tablet is screwed to the first horizontal rod, and the second horizontal rod and the third horizontal rod are screwed to a chute of the vertical rod.

10. The apparatus of the full mouth reconstruction method as claimed in claim 1, wherein the second recording device is comprised of an arc upper seat, an upper plotting board with a connecting portion disposed at an end, an arc lower seat, and a lower plotting board, and the upper plotting board is installed at the bottom of the upper seat, and the lower plotting board is installed at the top of the lower seat, and the lower plotting board and the upper plotting board are attached with each other, and the upper seat, the upper plotting board, the lower seat and the lower plotting board are fixed by a plurality of screws.
